(19) United States
(12) Patent Application Publication
(10) Pub. No.: US 2022/0363153 A1
(43) Pub. Date: Nov. 17, 2022

(54) providing a mobile service for charging the batteries of electric vehicles

(71) Applicant: Daniel Harrison Dudley, Bullhead City, AZ (US)

(72) Inventor: Daniel Harrison Dudley, Bullhead City, AZ (US)

(21) Appl. No.: 17/320,698

(22) Filed: May 14, 2021

(51) Int. Cl. B60L 53/18

(52) U.S. Cl. CPC B60L 53/18

(57) ABSTRACT

Abstract of this patent idea is adapting any type or method of electric vehicle battery charging, to provide this mobile charging service.

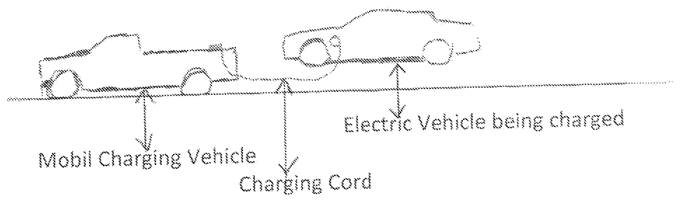

Specification of invention idea examples may involve vehicle mounted independent dedicated charging generators, which operate from a separate fuel source, adapted to charge batteries of electric vehicles.

Another example may involve adapting larger storage batteries that have the capacity to charge electric vehicles which can be used to provide this mobile service. Further examples may also involve other electric vehicles being adapted or having the capacity to charge other electric vehicles, which could be retained, hired or work as independent contractors by the holder of this patent, to provide this mobile charging service.

1. Claims will allow this patent holder the patent protections allowed to be the single United States provider of this mobile electric charging service.
